(19) United States
(12) Patent Application Publication
(10) Pub. No.: US 2016/0288625 A1
(43) Pub. Date: Oct. 6, 2016

(54) LOUVER AND AIR VENT HAVING AT LEAST ONE LOUVER

(71) Applicant: DR. SCHNEIDER KUNSTSTOFFWERKE GMBH, Kronach (DE)

(72) Inventors: OLAF UHLENBUSCH, MARKTZEULN (DE); MICHAEL SCHNEIDER, ALTENKUNSTADT (DE); KAMAL MATRANE, DORTMUND (DE)

(21) Appl. No.: 15/034,486

(22) PCT Filed: Nov. 13, 2014
(86) PCT No.: PCT/EP2014/074530

§ 371 Date: May 4, 2016

(30) Foreign Application Priority Data
Nov. 21, 2013 (DE) 10 2013 112 850.5
Feb. 26, 2014 (DE) 10 2014 102 533.4

(51) Int. Cl. B60H 1/34; F24F 13/14

(52) U.S. Cl. CPC B60H 1/3421; F24F 13/14; F24F 13/1406; B60H 1/3407; B60H 2001/3492

(57) ABSTRACT

Provided is a louver, which in particular has an elongated form, and to an air vent having at least one louver. The louver has a front region that takes up an entire longitudinal direction and a back region, wherein the front region and the back region are made of materials that differ in mechanical properties. The material of the front region preferably has a relatively high flexural stiffness in a longitudinal direction (x), whereas the material used for the back region has a flexural stiffness that is significantly lower than the flexural stiffness of the front region. The back region of the louver is longer than the front region in a transverse direction (y).

The present invention relates to a slat and to an air vent with at least one slat. Claim 1 concerns the features of the slat and claim 5 reproduces the features of the air vent.

By “slat” there is understood by the present invention parts in a motor vehicle, for example in a passenger motor vehicle or a goods motor vehicle, which have a greater length dimension than width dimension. Such parts find use in many areas. According to the invention, slats in a slat arrangement in a housing of an air vent have structures of that kind. In that regard these can be vertically and/or horizontally arranged slats or slats in rotatable nozzles, which can adopt any inclined position.

If a slat in an air outlet opening of an air vent, which is usually made of plastic, has a greater length or—in the case of vertical arrangement—a greater height, an increased mechanical loading of the slat arises when it is actuated and this can lead to it being warped.

It has additionally proved that even with slats which are relatively free of mechanical loading, distortions of that kind—particularly in the case of longer-term use and higher levels of thermal loading—can occur, particularly if the slats are of very thin construction.

Air vents for use in motor vehicles are common knowledge, Air vents of that kind usually comprise separate slat blocks which are arranged to be offset relative to one another through an angle and by means of which the air flow introduced into the air vent and controlled by means of the air vent is to be directed in its orientation.

A slat for a horizontal and/or vertical slat arrangement in a housing of an air nozzle with a front air outlet opening and a connection to an air feed shaft is disclosed in DE 20 2006 004 052 U1. At least one slat is constructed as a rotary or slide element. The at least one slat is connected with a setting element or an indicating element and consists of plastic with a stiffening metallic insert member inserted in longitudinal direction.

In order to stiffen the slat, which is provided with a setting element or constructed as a control slat, so that it is appropriate to the mechanical loads and warping is avoided it is proposed in DE 20 2006 004 052 U1 to construct the slat as a composite part and to embed in longitudinal direction a reinforcing metallic insert member which extends over substantially the entire length of the slat and is surrounded for the most part or entirely by the plastic.

A slat grille, which consists of plastic, of an air nozzle—which preferably is able to be installed in a motor vehicle—with a plurality of pivotable slats is known from DE 20 2004 008 181 U1. A longitudinally displaceable slide is arranged on at least one slat and is connected with at least one directional slat arranged to be pivotable transversely to the slats in the ventilation housing.

A piezoelectric drive in the form of a rotor consisting of long-life polymers is disclosed in U.S. 2005/0012433 A1. Fibres of carbon, metal or fibreglass are integrated in the polymer in order to produce this rotor.

A blocking device for a ventilation opening, particularly for an air-conditioning installation, with a frame and a blocking element arranged in the frame to open and close the ventilation opening is disclosed in DE 195 10 637 C1. The construction of the blocking device is such that the blocking element is formed from a plurality of slats, mutually adjacent slats being pivotably interconnected at the edge sides thereof parallel to the pivot axis.

A wind deflector for a roof opening of a motor vehicle is disclosed in EP 1 342 601 A1. This consists of different components of plastic forming a body. This body consists of a base body ensuring stability of shape and strength and elements of soft plastics material injection-moulded thereon.

An air nozzle with an adjustable slat grille is disclosed in DE 102 25 811 B4. The nozzle comprises a housing and a cover screen enclosing the visible end region. The slat grille consists of a plurality of parallel slats arranged at a mutual spacing and at least one slat cog which extends transversely to the longitudinal direction and interconnects the slats, the slats being pivotably mounted by means of integrally formed fulcrum pins mounted in stationary position relative to the housing and the slats being produced in common with at least one slat cog in the production process by plastics material injection-moulding. The slat grille is formed entirely as a constructional unit and can be inserted into the housing.

An air nozzle with slats with at least one setting element operable by way of a drive and for regulating the air flow, particularly for a ventilating system for a motor vehicle, is known from DE 10 2004 046 059. The setting element comprises a plurality of slats. At least one further setting element is actuable by way of a drive of the setting element.

An air vent for the interior space of a vehicle is known from DE 10 2004 062 935 A1. The air vent comprises a slat block which is arranged at the air outlet side of an air flow channel in a housing and which consists substantially of parallel and mutually spaced-apart pivotable slats forming flow slots. Of the slats, at least one has an at least partly blocking closure arm for one of these flow slots. By means of such a slat an air vent can be designed in such a way that directional impairment of the air flow by the housing wall when the air flow is deflected by the slat block, as well as visual and acoustic impairment, are excluded, the latter at least substantially reduced. For that purpose the closure arm is arranged at an edge slat of the slat block, facing a wall region of the housing, and the wall region has an opening slot or a cut-out for this.

A blocking element in a flow channel constructed with a movable torsion arm and/or journalled closure member and a contact region for the closure member is known from DE 199 48 218 A1. The closure member is adjustable between a closed setting sealingly bearing against the contact region and a maximum open setting, raised from the contact region, of the closure member. At least one of the regions, which bear against one another in the closed setting, of the closure member or the contact region is of resilient construction and resiliently deforms in the closed setting. In a defined predetermined setting range, which is near the closed setting, of the closure member a channel opening region bounded exclusively by regions of the closure member and the contact region is present. The absolute change in area of the channel opening region available for throughflow is smaller, due to resilient deformation of the resilient region—which forms the closure—of the closure member and/or of the contact region for the same adjustment travels of the closure member, within the setting range of the closure member near the closed setting than outside this setting range.

It is disadvantageous with the known prior art that the known air vent has to have a certain dimensioning and size as a consequence of the slat blocks let into the front side.

The present invention has the object of indicating a slat which enables particularly good guidance of an air flow in a housing. A further aspect of the invention is to indicate an air vent with a corresponding slat.

This object is fulfilled by way of the features of claim 1 and the features of claim 5.

Advantageous embodiments of the invention are illustrated in the subclaims, the further description and, in particular, by way of the description based on actual embodiments with reference to figures.

The slat according to the invention, which has, in particular, an elongated form, consists of a front region occupying almost the entire length direction and a back region, wherein the front region and the back region consist of materials, preferably plastics materials and especially thermoplastic plastics material, differing in the mechanical characteristics thereof. The material of the front region has a relatively high bending stiffness preferably in longitudinal direction, whereagainst the material used for the back region of the slat has a significantly lower bending stiffness by comparison with the front region. The back region of the slat is formed to be longer in transverse direction than the front region. The selection of the mechanical characteristics of the materials for the front region and the back region makes it possible to produce a slat which is of stable shape and capable of accepting mechanical loads and which at the same time has a good air guidance property. The slat can be positioned or integrated by the front region in or at an arrangement such as, for example, a slat block or a Venetian blind mount. The front region is capable of mechanical loading and is stiff in bending. The slat can thus be formed to be relatively long and thin by comparison with a conventional slat. By virtue of the material for the back region, which has a lower bending stiffness and, for example, can be a so-called soft plastic, desired further mechanical properties can be fulfilled for a slat so that, for example, the back region quasi nestles against an adjoining object or surface or surface region. Moreover, downward bending due to gravitational force and the intrinsic weight of the slat, particularly the back region of the slat, is easy in the case of a planar arrangement of the slat in the horizontal.

In an advantageous embodiment of the invention according to claim 2 it is provided that the back region of this slat is at least twice as long in transverse direction as the front region of the slat. The front region and the back region of the slat merge into one another in interlocking manner. No transitions are perceptible to the eye of a user. The transition between the front region of the slat and the back region of the slat is formed without contours. The possibility of bending of the slat in the area of the back region arises due to a longer form of the back region. The slat has a flat, wavy and/or polygonal cross-sectional structure.

In an advantageous embodiment of the invention according to claim 3 it is provided that the front region and the back region of the slat consist of thermoplastic plastics material with the front region having a modulus of elasticity of at least 12,000 MPa and the back region a modulus of elasticity of at most 5,000 MPa and that the slat is produced in a two-component injection-moulding process with fibres of carbon, metal, glassfibre or plastic with a roughened surface or metal thread sections being added to the thermoplastic plastics material of the front region. On the one hand, through selection of the fibres it is possible to influence the modulus of elasticity and on the other hand the material selection and/or the resulting surface structure of the fibres are of significance and thus the way in which the fibres bond in the molecular structure of the plastics material, as a result of which the material property of an article produced with the mixture of plastics material and added fibres can be influenced. The slat can be produced in a unitary production process by a two-component injection-moulding method. The selection of a high modulus of elasticity for the front region guarantees good stability and stiffness of the slat, and through the selection of a low modulus of elasticity for the back region the desired characteristics of the slat with respect to mechanical contact with adjoining and/or contacting surfaces or elements are made possible. Alternatively, the slat can be produced by means of hybrid technology, i.e. the front region of the slat could consist of metal such as, for example, cast zinc, cast aluminium, steel or aluminium and the back region of the slat of a thermoplastic plastics material, which can be injection-moulded on or around or even attached.

As an alternative to a soft thermoplastic for the soft back region of the slat use can also be made of a thin film or several thin films layered one on the other. The low modulus of bending in this variant would be advantageous.

In an advantageous embodiment of the invention according to claim 4 it is provided that due to the lower stiffness in bending the back region of the slat is bendable in transverse direction without breakage of the slat and nestles against adjoining contact surfaces to produce an almost shape-coupled termination or a seal with contact surfaces. The desired characteristics of the slat with respect to mechanical contact with adjoining and/or contacting surfaces or elements are thus achieved.

An air vent with a slat according to the invention and in accordance with the preceding claims is stated in claim 5. The air vent consists of a housing having a front air outlet opening and a rear connection to an air feed shaft for the supply of an air flow. The at least one slat is so arranged at a support unit in the front region of the housing that the air flow is deflectable by means of the at least one slat, wherein the position of the at least one slat in the housing is variable in horizontal direction within the housing by means of the support unit and/or the slat is mounted on the support unit to be rotatable about a horizontally extending axis or the at least one slat is arranged at the support unit to be stationary in the housing. The air flow guided through the housing of the air vent can be influenced and/or deflected in its orientation, when exiting from the air outlet opening, by the at least one slat. The air flow can be additionally influenced in its orientation by further measures.

In an advantageous embodiment of the invention according to claim 6 it is provided that the support unit is a strut or a roller, the roller being rotatably mounted in the region of the air outlet opening of the housing and the struts being arranged in the region of the air outlet opening of the housing.

In an advantageous embodiment of the invention according to claim 7 it is provided that the housing inner wall of the housing forms, in the region of the air outlet opening, a Cassinian curve in the form of a lemniscate or an arc, the radius of which reduces in the direction of the air outlet opening and forms a constriction in the region of the contact surface between the back region of the at least one slat and the housing inner wall of the housing.

In an advantageous embodiment of the invention according to claim 8 it is provided that a grille can be arranged in front of or in the air outlet opening to close this in interlocking manner.

In an advantageous embodiment of the invention according to claim 9 it is provided that the grille is formed by horizontally and vertically arranged webs and cut-outs defined between the webs, the cut-outs being formed at different directional angles, wherein the directional angles of the cut-outs present in the air outlet opening in a horizontal central region extend perpendicularly to the webs, the directional angles of the cut-outs above this region have an upwardly inclined angle and the cut-outs below this region have a downwardly inclined angle, this angle being between 30° and 45° in an advantageous embodiment of the invention. Through the grille and the special design of the grille it is possible to set preferential directions for the air flow passing through the grille. In the centre, the preferential direction is horizontal, while in the upper region the air flow is deflected upwardly through the cut-outs in the grille and downwardly in the lower region. The grille can consist of plastic and be of single-part or multi-part construction to the extent that as a consequence of its thickness and the undercuts resulting therefrom it no longer has to be removable from a mould. The grille can also consist of a deep-drawn metal, in which case the passages would be punched. The preferential directions can be formed either in a vertical plane or in a horizontal plane. The grille can also have preferential directions in ‘four directions’ (horizontal and vertical), for example if a more diffuse (widened, wider) air flow is desired.

In an advantageous embodiment of the invention according to claim 10 it is provided that the grille in the form of a roller blind, consisting of flexible material, can be pushed in front of the air outlet opening or in the form of a visor can be pivoted in front of the air outlet opening, in which case the grille can be pivoted or pushed into the housing. As a result, a user can, if required, bring the grille into a use position or on the other hand use the air outlet opening without a grille. The grille can be pushed into the housing of the air vent or above, below or laterally thereof.

In an advantageous embodiment of the invention according to claim 11 it is provided that an arrangement for guidance and/or deflection and/or suppression of the supplied air flow, which can be fed from an air feed shaft or from an air feed duct in heating, ventilating or air-conditioning installations, particularly for passenger compartments in motor vehicles, is disposed in the housing and that the housing is insertable into a wall passage or is mountable behind such and that the arrangement is formed from at least two separate elements offset relative to one another by an angle and/or arranged one behind the other, so that the supplied air flow is settable, deflectable or almost entirely suppressible in its flow direction, wherein the elements are at least one respective slat or at least one slat block, wherein a slat block comprises a plurality of intercoupled slats and wherein each of the intercoupled slats of a slat block is mounted in the slat block in such a way the slats of a slat block are pivotable in common about an axis.

In an advantageous embodiment of the invention according to claim 12 it is provided that a throat is provided in the housing, the throat being formed by means of a funnel. The air flow is accelerated by this throat with utilisation of venturi effect and can be better directed by the at least one slat.

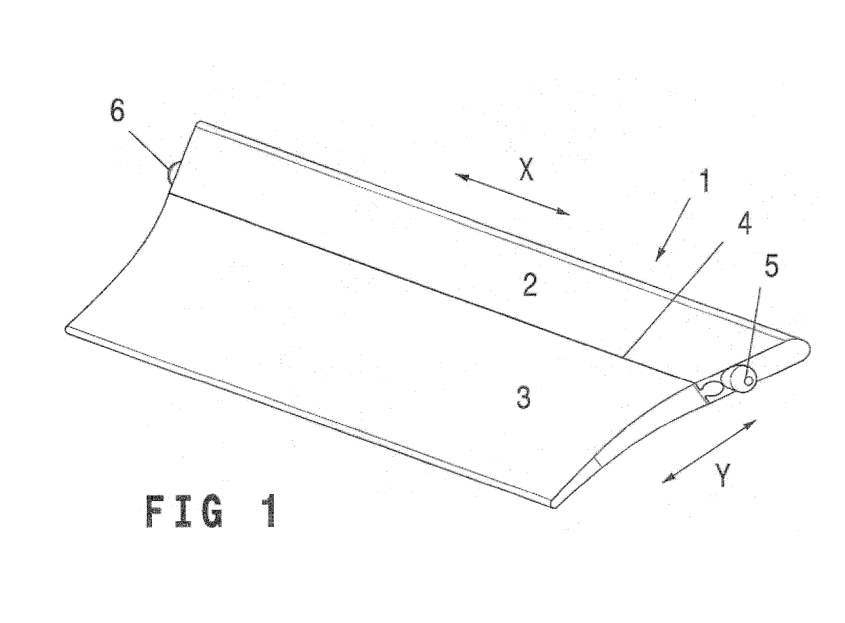

The invention is illustrated in the following on the basis of actual embodiments with reference to the accompanying figures FIG. 1 to FIG. 11.

This description on the basis of actual embodiments does not represent limitation of the invention to any one of these actual embodiments.

The same reference numerals are allocated to the same elements in the figures and in the description of the figures. This serves for better clarity and comprehension of the following description.

FIG. 1 shows a slat in perspective illustration;

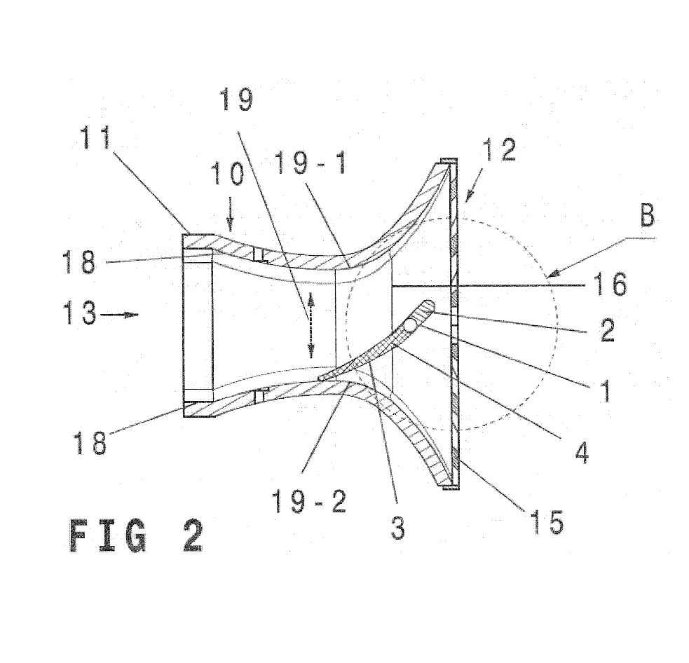

FIG. 2 shows a longitudinal section through an air vent;

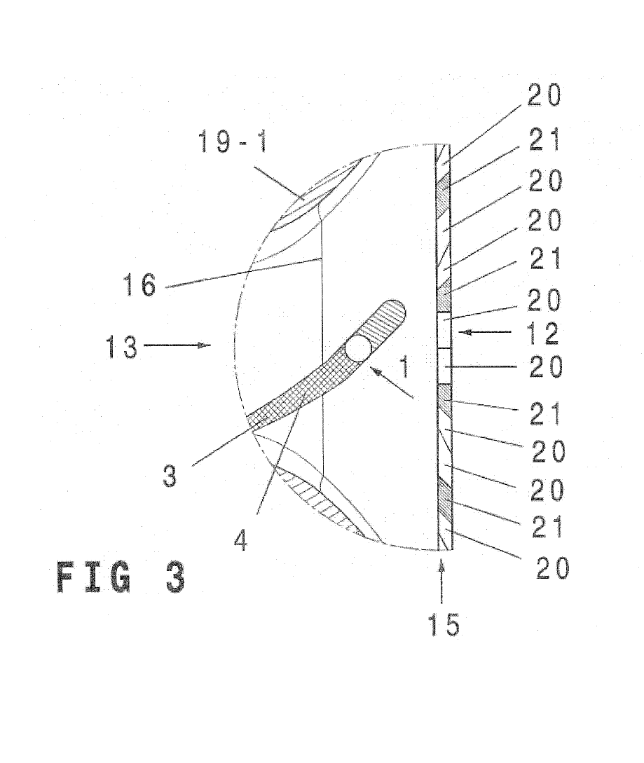

FIG. 3 shows a detail view of FIG. 2, denoted therein by B;

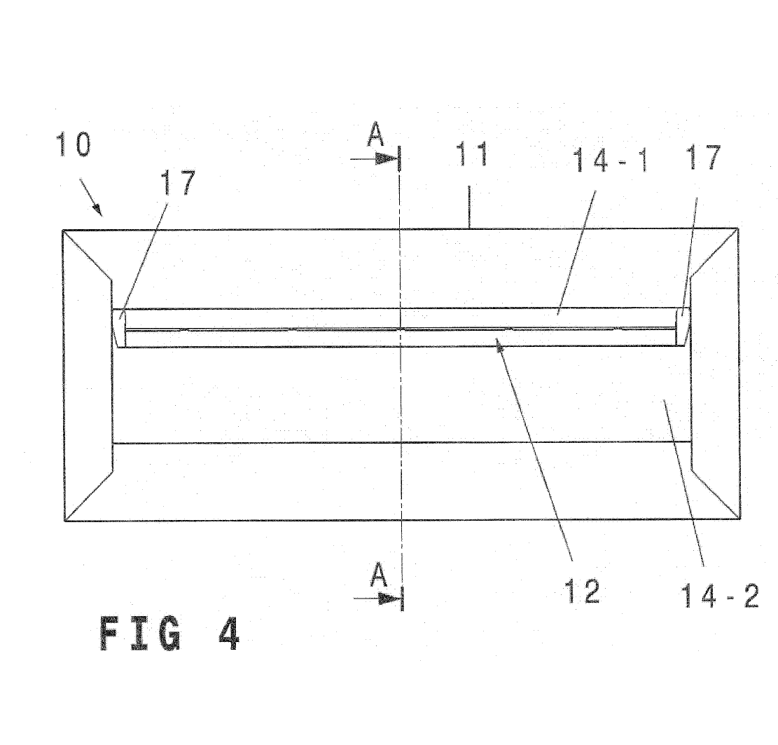

FIG. 4 shows an air vent in front view;

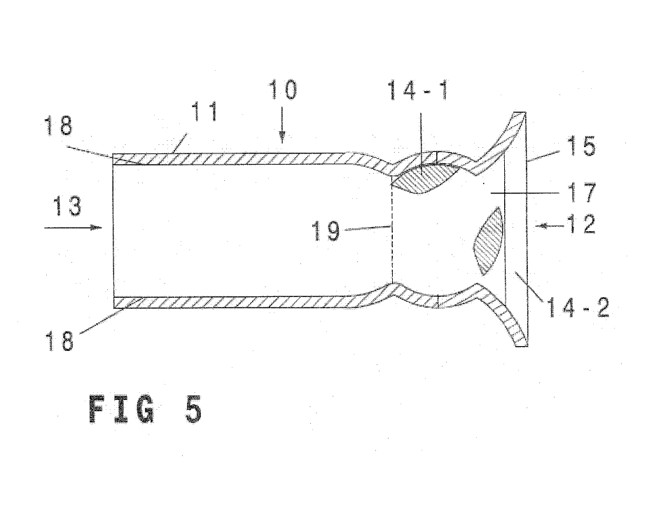

FIG. 5 shows a longitudinal section through an air vent according to FIG. 4;

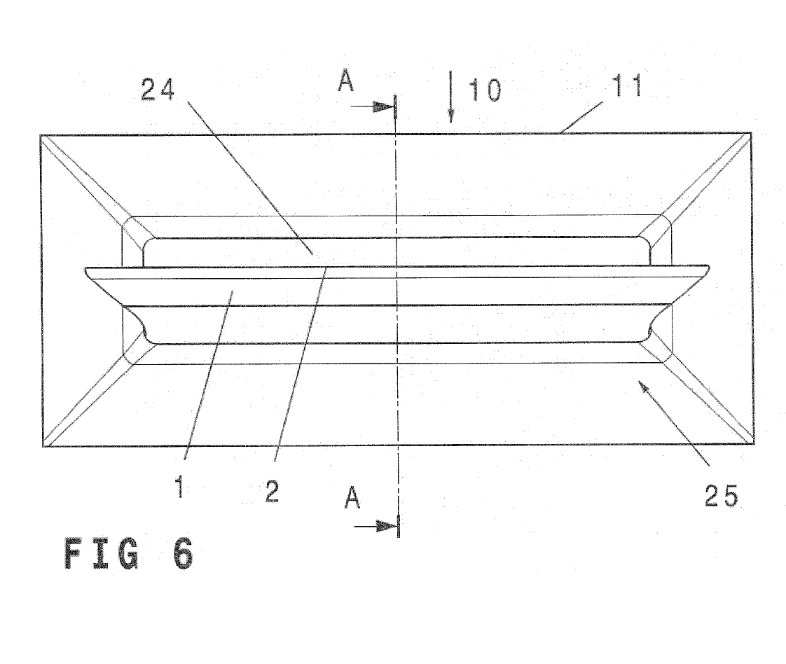

FIG. 6 shows an air vent in front view;

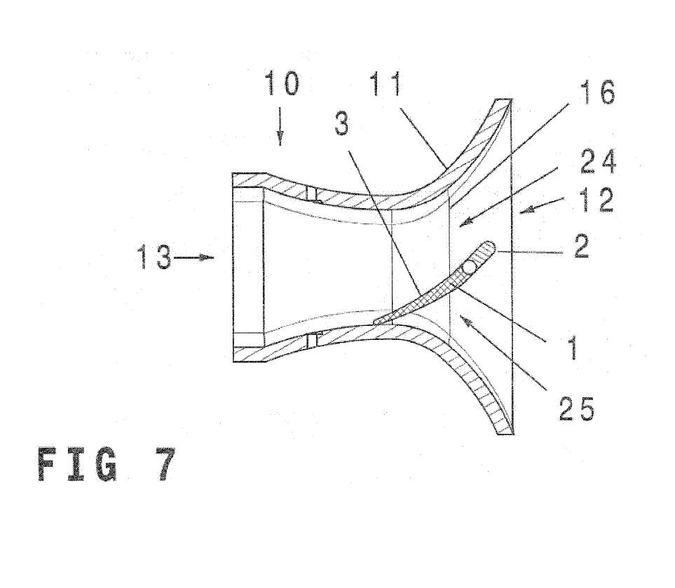

FIG. 7 shows a longitudinal section through an air vent according to FIG. 6;

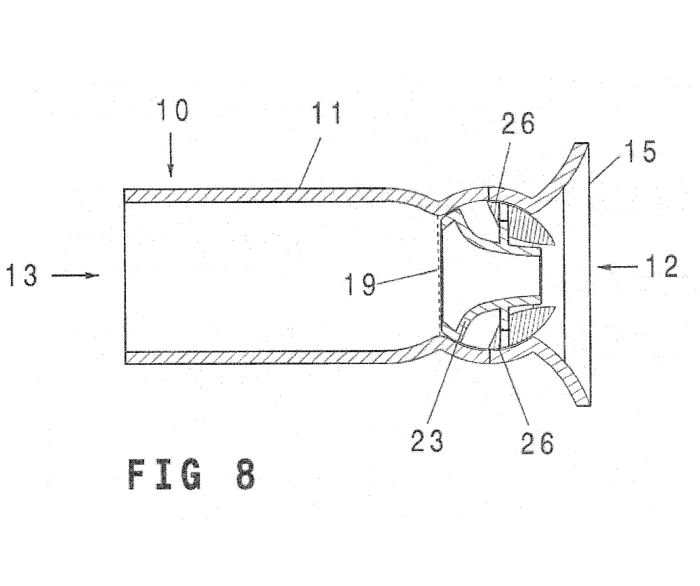

FIG. 8 shows a longitudinal section through an air vent;

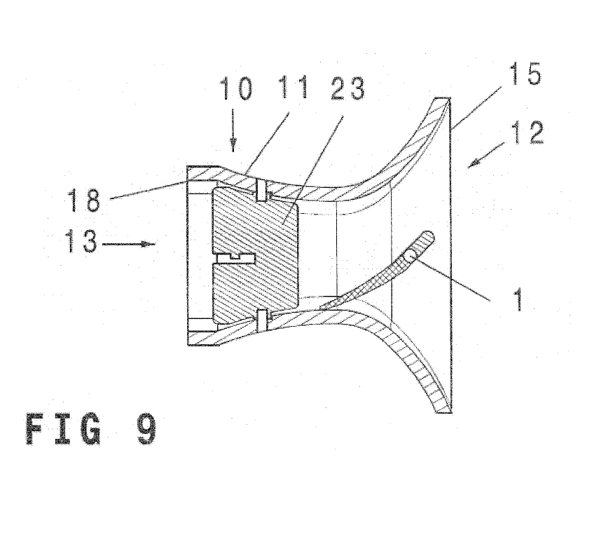

FIG. 9 shows a longitudinal section through an air vent according to FIG. 8;

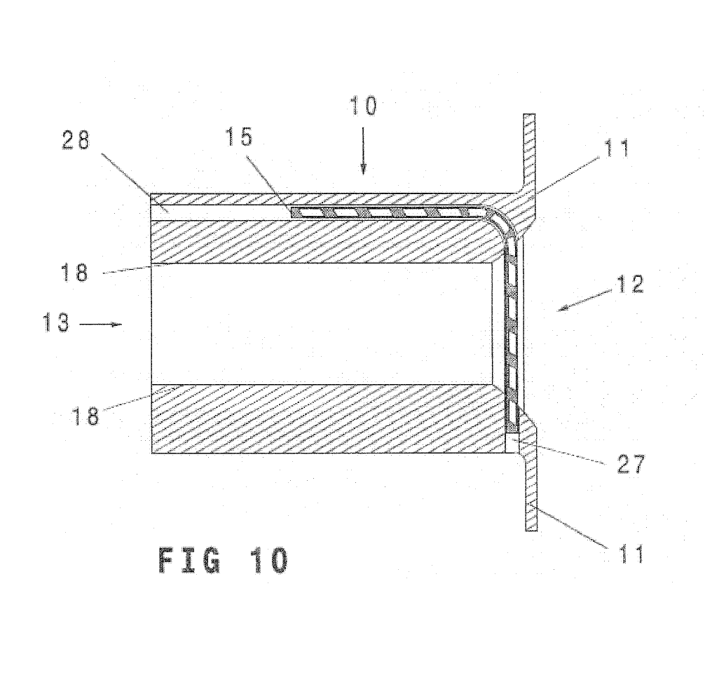

FIG. 10 shows an embodiment of the grille as a roller blind; and

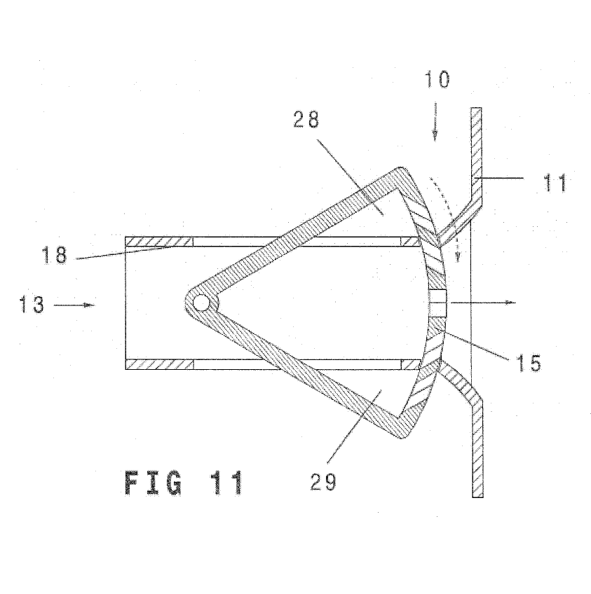

FIG. 11 shows an arrangement of the grille as a pivoting visor.

An embodiment of a slat 1 according to the invention is illustrated in FIG. 1. The slat 1 consists of plastic and is provided, in its configuration according to FIG. 1, for insertion into and/or installation in an air vent in vehicles, preferably motor vehicles. The slat 1 is furnished with shaped-on and shaped-out portions 5, 6 for connection with other components or for mounting on or for fastening of components. The slat 1 essentially consists of two regions, namely the front region 2 and the back region 3. The front region 2 consists of thermoplastic plastics material, to which additives are added. In an advantageous embodiment of the invention the front region 2 consists of polyamide or polyarylamide mixed with short fibres, the fibres being carbon fibres, metal thread lengths or fibres of plastic with roughened surface, glassfibres or metal threads.

The slat 1 has a cross-sectional structure which is preferably of flat construction, but can also be formed to be wavy or also polygonal. Equally, the slat can have flat, wavy or also dispersed polygonal structures in elongate direction; structures departing from the planar form are dependent on use and contribute to stiffening.

In the embodiment according to FIG. 1 the slat 1 is provided for the purpose of being arranged to be fixedly installable or pivotably mounted as an elongate member in a slat arrangement with further slats or as an individual slat in a housing of an air vent with a front air outlet opening and a rear connection to an air feed shaft.

The slat 1 has laterally protruding shaped-out portions 5, 6 in the form of bearing pins at the upper and lower end surfaces. The bearing pins can be shaped from the plastics material of the slat 1 or be protrusions formed from an insert member injection-moulded around by the plastics material of the slat 1. The insert member 1 can have protrusions which extend in the bearing pins consisting of plastics material.

In a further advantageous embodiment of the slat 1 it is provided that the slat 1 has, in the front region, a bead-shaped thickening over at least a part length so as to swirl or provided better discharge of the air flow exiting the air vent.

Polyamide (PA) or polyarylamide (PPA), which is mixed with fibres, can be used as plastics material for the front region 2 of the slat 1, so that slats with a high level of bending stiffness can thus be produced inexpensively, these having a desired high level of stiffness for a low constructional height or low thickness.

Advantageously, this plastics material is suitable for the production of slats for air nozzles, irrespective of kind and shape, as well as for Venetian blind slats, for production of Venetian blinds of very diverse widths and sizes, which also have a high level of stability and stiffness. In the case of use of fibres with a roughened surface the polyamide or polyarylamide can penetrate into the pores and assist bonding.

If the front region 2 of the slat 1 is produced from this material, then this region can also be partially metallised so that it is thereby possible to also realise current-conducting tracks. Equally, complete metallisation is possible, for example chroming. Use of this material has, moreover, shows that the stability of shape is of such a high level that even after stress or ageing tests there is no warping, particularly not even when temperatures in the range above 100° C. are reached due to direct radiation of sunlight. This is attributable to the included fillers such as, for example, the fibre material.

For the thermoplastic plastics material for the front region 2 of the slat 1 as well as for the back region 3 use is preferably made of linear and/or partly aromatic polyamides as well as mixtures thereof. Polyamides are polymers with regularly repeating amide bonds along the main chain. The amide group can be obtained as a condensation product of a carboxylic acid and an amine. The resulting compound is an amide compound which can be hydrolytically split again.

Due to their excellent strength and toughness, polyamides are often used as constructional tools. They have good chemical resistance to organic solvents. However, there is still the possibility of polyamides being attacked by acids or oxidising chemicals. In order to influence the properties of the plastic further in the direction of the desired stability and bending stiffness, fibres and/or further constituents are admixed to the polyamides.

In plastics engineering an important characteristic for the mechanical property of a plastic is the so-called modulus of elasticity or, for short, E modulus, which is also termed Young's modulus after the physicist Thomas Young. The modulus of elasticity is a material characteristic value from materials technology which describes the correlation between stress and strain in the deformation of a solid body with linear-elastic behaviour. The value of the modulus of elasticity is greater the more resistance a material has to deformation thereof. A material with a high modulus of elasticity is stiff. A material with a low modulus of elasticity is flexible. The modulus of elasticity is the proportionality constant in Hooke's law. In the case of crystalline materials the modulus of elasticity is basically directionally dependent. As soon as a material has a crystallographic texture the modulus of elasticity is anisotropic.

The front region 2 of the slat 1 is selected in such a way that through admixture of fibres and/or additives to the plastics material the slat 1 in the front region 2 has a modulus of elasticity or E modulus of at least 12,000 MPa. This is achieved by admixture of the additives.

The back region 3 of the slat 1 is selected in such a way that the back region 3 of the slat 1 has a modulus of elasticity or E modulus of at most 5,000 MPa.

The slat 1 inclusive of the front region 2 and the back region 3 can be produced by means of a known two-component injection-moulding method. The thermoplastic plastics material described in the introduction can be processed without restriction.

The slat 1 has an elongate form, which is substantially larger in longitudinal direction x than in transverse direction y. The front region 2 extends over the entire longitudinal direction x of the slat 1. The back region 3 is articulated to the front region 2 and is injection-moulded at the front region 2 in a two-component injection-moulding process. The front region 2 has, as already mentioned, different mechanical characteristics, in particular a higher flexural loading from the back region 3. The back region 3 is oriented in its characteristic or mechanical loading towards flexibility so that, in particular, the rear region of the back region 3 nestles against an adjoining plane or surface and even partly seals this. The back region 3 has a substantially lower bending stiffness by comparison with the front region 2. The back region 3 is formed to be significantly longer in transverse direction y by comparison with the front region 2.

In an advantageous embodiment of the invention the back region 3 runs towards the end of the slat 1 no as to taper in transverse direction y. The slat 1 thus has a form of aircraft aerofoil shape.

In an advantageous embodiment of the invention it has proved that the slat 1 fulfils its function particularly satisfactorily if the back region 3 of the slat 1 is selected to be at least twice as long in transverse direction y as the front region 2 of the slat 1.

The front region 2 and the back region 3 of the slat 1 merge in interlocking manner and do not form contours in the transition zone 4, so that visually the slat 1 represents a unit. The transition zone 4 between the front region 2 and the back region 3 is free of contours. The transition zone 4 has, however, a characteristic, namely that the slat 1 is bendable in transverse direction y starting from the transition zone 4.

A transition zone 4 capable of accepting particularly strong mechanical loads forms between the front region 2 and the back region 3 of the slat 1 by virtue of the fibres and/or fillers present in the front region 2. The front region 2 and the back region 3 enter into a stable connection.

A slat block consists of at least two slats 1, which are arranged parallel to one another in the slat block and which are mounted by way of a device—present in or at the slat block—to be pivotable in common about an axis preferably extending through the bearing pins of the slat 1.

A section through an air vent 10 in which a slat 1 according to the invention is arranged is illustrated in FIG. 2. The air vent 10 consists of a housing 11 having a front air outlet opening 12 and a rear connection 13, which serves the purpose of connection with an air feed shaft for the supply of an air flow. The air vent 10 is provided for the purpose of being used in a heating/ventilating or air-conditioning installation, particularly for passenger compartments in vehicles, the housing 11 being insertable into a wall passage or mountable behind such.

The slat 1 is arranged in the housing 11 of the air vent 10. The front of the slat 1 is disposed with the front region 2 arranged approximately horizontally centrally in the region of the air outlet opening 12; the slat 1 is slightly recessed by the front region 2 into the housing 11. A support unit 16 is provided in the housing 11 and journals the slat 1 in the transition zone 4 of the slat 1. However, the bearing pins at the slat 1, which are not illustrated in FIG. 2, can also be used to rotatably mount the slat 1 on the support unit 16. The slat 1 is so mounted on the support unit 16 that the slat 1 is adjustable from a lower maximum deflection position, as illustrated in FIG. 2, to an upper maximum deflection position. This adjustment can be carried out mechanically by a user via an appropriate actuating device (not illustrated in FIG. 2) or, however, by way of an electrically operated setting unit (similarly not illustrated in FIG. 2). The slat 1 can be brought into any position between the lower maximum deflection position as illustrated in FIG. 2 and the upper maximum deflection position.

In an advantageous embodiment of the invention the support unit 16 is a strut pair extending from the top in downward direction within the housing 11. In a further advantageous embodiment of the invention a roller, which is rotatably mounted in the region of the air outlet opening 12 in the housing 11, is provided instead of the strut pair.

The air flow supplied to the air vent 10 by way of the rear connection 13 is influenced and deflected in its orientation, when exiting from the air outlet opening 12, by means of the slat 1 and the front and back regions 2, 3 thereof.

In the lower maximum deflection position illustrated in FIG. 2 the flexibly designed back region 3 of the slat 1 nestles against the lower inner side 18 of the housing 11 and quasi seals with the lower inner side 18 of the housing 11 no that the air flow is necessarily deflected by way of the slat 1 and cannot flow at least partially thereunder. In the upper maximum deflection position the flexibly designed back region 3 of the slat 1 nestles against the upper inner side 18 of the housing 11 and quasi seals with the upper inner side 18 of the housing 11 so that the air flow is necessarily deflected by way of the slat 1 and cannot flow at least partially above this.

Through use of a slat 1 according to the invention in an air vent 10 a defined direction of the air flow is thus achieved.

A grille 15 can be introduced into the air outlet opening 12 of the housing 11 of the air vent 10 or be fixedly arranged there.

The housing inner walls 18 extend rectilinearly in the region of the rear connection 13, the shape of the housing inner walls 18 in the region of the air outlet opening 12 being formed in each of the upper and lower regions in the direction of the air outlet opening 12 in the form of a Cassinian curve in the shape of a lemniscate 19-1, 19-2, or, however, the housing inner walls 18 are formed in each of the upper and lower regions in the direction of the air outlet opening 12 in the form of an arc, the radius of which reduces in the direction of the air outlet opening 12 and defines a constriction 19 in the region of the contact surfaces between the back region 3 of the slat 1 and the housing inner wall 18.

A Cassinian curve is the sum of all points having, from two fixed points, a distance which forms a constant product.

The formation of the inner walls 18 in the region of the air outlet opening 12 in the shape of, in particular, a lemniscate guarantees a particularly advantageous air flow from the air outlet opening 12 of the air vent 10, since the air flow is accelerated by way of the constriction 19. The air flow is accelerated with utilisation of venturi effect and can be directed particularly satisfactorily by the slat 1.

In an advantageous embodiment of the invention the slat 1 is so arranged in the housing 11 that the back region 3 of the slat 1 slightly protrudes beyond the constriction 19 in the direction of the rear connection 13.

By virtue of the constriction 19 and the specific design of the inner walls 19-1, 19-2 the flow follows the inner walls 19-1, 19-2. As a result. Coanda effect is utilised. The deflection of the air flow, notwithstanding the orientation of the slat 1 with only 30° inclination relative to the air flow direction, can thus enable a deflection of 50°, in any event at least 32° with an upstream grille 15. In the case of a slat setting of 45°, the air flow can be deflected by up to 53°, a deflection of up to 38° being possible with an upstream grille 15.

A detail of FIG. 2, which is denoted in FIG. 2 by B, is illustrated to enlarged scale in FIG. 3. The upper inner wall 19-1 is illustrated just partly.

A part detail of the slat 1 with its front region 2 and the back region 3 is depicted. In addition, the transition zone 4, at which for preference the rotatable mounting of the slat 1 at the support unit 16 is provided, is illustrated.

An apertured screen in the form of the grille 15 is illustrated in front of or in the air outlet opening 12 of the air vent 10. The grille 15 has struts 21 and cut-outs 20, the cut-outs 20 preferably being formed as bores. The cut-outs 20 have the same orientation. In the centre region of the grille 15, in a horizontal plane, the cut-outs 20 are provided perpendicularly in the grille 15. Above and below this region the cut-outs 20 differ in the angle thereof at which they are formed, respectively, in the direction of the upper side and lower side of the housing 11, so that the cut-outs 20 in the lower region are inclined at an acute angle of 30° relative to the lower side of the housing 11 and in the upper region at an acute angle of 30° relative to the upper side of the housing 11.

The air flow issuing from the air outlet opening 12 can be additionally influenced, particularly in the direction of a diffuse air distribution, by this shaping of the cut-outs 20 of the grille 15.

In a further advantageous embodiment of the invention the grille 15 is divided into segments, for example, circular segments or circular rings, and the angles of the cut-outs 20 in the segments are selected to be different.

In a further advantageous embodiment of the invention, particularly in the case of rectangular air vents, it has proved advantageous to arrange in the centre of the grille 15 a region in which the cut-outs 20 are formed to extend horizontally over the entire width of the grille 15 and to increase the angles of the cut-outs in segments of the grille 15 disposed thereabove and thereunder, for example to change them respectively by an increase of 10° or minus 10°. If, for example, three segments are present above and below the centre region, then the cut-outs 20 are formed in the first segment at 10°, in the second segment at 20° and in the third segment at 30°.

In an advantageous embodiment of the invention the grille 15 has a thickness of at least 2.5 millimetres.

An air vent 10 is illustrated in FIG. 4 in front view. The air vent 10 again has a rear connection 13 for the feed of an air flow. An air outlet opening 12 is present in the front region. The inner wall 18 of the housing 11 of the air vent 10 extends rectilinearly in the region of the rear connection 13. A constriction 19 which reduces the inner diameter of the housing 11 is provided.

A roller 17, which is offset rearwardly to some extent, is rotatably arranged in the region of the air outlet opening 12, The roller 17 is designed so that it does not have any circumferential surface in the region which comes to lie within the housing 11, but corresponding cut-outs are present so that the roller 17 does not influence the air flow. A respective slat 14-1 or 14-2 is arranged at the roller 17 in each of the upper region and lower region. The slats 14-1, 14-2 can be rotatably, i.e. adjustably, mounted at the roller 17; in another embodiment the slats 14-1, 14-2 are fixedly arranged at the roller 17. Through rotation of the roller 17 the orientation of the air flow can be varied by way of the slats 14-1, 14-2.

A section through the air vent according to FIG. 4 is illustrated in FIG. 5; the section line is denoted in FIG. 4 by A-A.

The constriction 19 in the housing interior is illustrated. The roller 17 is arranged in the housing 11 to be slightly rearwardly offset in the air outlet opening 12. The maximum orientation of the slats 14-1, 14-2 in order to deflect to the air flow upwardly is illustrated in FIG. 5.

The roller 17 preferably has a lens shape, i.e. the roller 17 is formed to be lens-shaped in its region influencing the air flow. This is also particularly advantageous depending on flow.

A front view of an air vent 10 is illustrated in FIG. 6, the section—which runs A-A—through the air vent 10 being illustrated in FIG. 7.

The air vent according to FIGS. 6 and 7 comprises a housing 11, a rear connection 13 and an air outlet opening 12. The constriction 19 is present in the housing 11. In addition, as in the case of FIG. 2, a slat 1 is illustrated in the housing 11 in the lower maximum deflection position. In this position of the slat 1 the air flow guided through the housing 11 is deflected upwardly by the slat 1. The air outlet opening 12 has, in this setting of the slat 1, only an outflow region 24 through which the air flow issues from the air vent 10. The closure region 25 remaining underneath the slat 1 is almost completely sealed off by the back region 3 of the slat 1.

A section through a further air vent 10 according to the invention is illustrated in FIG. 8. In order to bound and accelerate the air flow a funnel-shaped V-slat in double-decker design 23 is arranged in the front region of the air vent 10, in front of which a slat—not illustrated in FIG. 8—can be arranged. The funnel-shaped V-slat of double-decker design 23 is advantageously arranged between the air outlet opening 12 and the constriction 19 to be slightly recessed in the air outlet opening 12. The funnel 23 is mounted to be rotatable about a horizontal axis of rotation in the housing 11. Through rotation of the funnel 11 the air flow can be changed in its orientation. In order that the funnel-shaped V-slat of double-decker design 23 is readily rotatable, the inner wall 18 of the housing 11 is provided with a coating 26 in the region of the funnel 23.

The funnel-shaped V-slat of double-decker design 23 is arranged, in FIG. 9, in the housing 11 to be offset further in rearward direction. The slat 1 is arranged in the housing 11 as in the case of FIG. 2. The air flow in the housing 11 is accelerated by the funnel-shaped V-slat of double-decker design 23. A grille 15 is arranged in front of the air outlet opening 12.

Through the use of the funnel-shaped V-slat of double-decker design 23 according to FIG. 9 the flow runs along the inner walls in the region of the air outlet opening 12 of the housing 11. Coanda effect can thus additionally be utilised.

Particularly advantageous embodiments of the grille 15 and the arrangement thereof in the air vent 10 are illustrated in FIGS. 10 and 11.

In FIG. 10 the grille 15 is designed in the form of a roller blind, which can be pushed in front of the air outlet opening 12 of the air vent 10. The grille 15 consists of flexible material or of pivotably interconnected segments. Present in the housing 11 is a storage region 28 into which the grille 15 can be pushed when not in use. The grille 15 in the embodiment as a roller blind is pushed into a receptacle 27 at the housing 11 and is fastenable or lockable thereat.

In Fig. lithe grille 15 is illustrated in the form of a pivot visor, which can be pivoted from a position, which is arranged above the housing, out of a storage region 28 above the air outlet opening 12 in the direction of a storage region 29, which is arranged below the air outlet opening 12, in or at the housing 11.

In an advantageous embodiment of the invention provision is made to design the grille 15 in the form of a roller blind or the pivot visor in the form of a superimposable double mask or a multi-layered mask. Each of the masks has a different profile of the cut-outs, so that when the masks are superimposed the air flow running through the masks is variable.

### REFERENCE NUMERAL LIST

1 slat

2 front region

3 back region

4 transition zone

5, 6 shaped-on/shaped-out portions

10 air vent

11 housing

12 air outlet opening

13 rear connection

14-1, 14-2 slat (integrated in cylindrical roller)

15 grille

16 support

17 roller

18 housing inner wall

19 constriction

19-1, 19-2 bulge

20 cut-out

21 web(s)

23 funnel-shaped V-slat of double-decker design

24 outflow region

25 closure region

26 coating

27 receptacle

28, 29 storage region

x longitudinal direction

y transverse direction

1-12. (canceled)

13. A slat having an elongate form, said slat having a front region occupying almost an entire longitudinal direction (x) and a back region, wherein the front region and the back region are formed of materials differing in their mechanical properties, wherein the material of the front region has a relatively high bending stiffness in the longitudinal direction (x), but the back region has a bending stiffness substantially lower by comparison with the front region, and the back region is formed to be longer in a transverse direction (y) than the front region.

14. The slat according to claim 13, wherein the back region of the slat is at least twice as long in the transverse direction (y) as the front region, and the front region and the hack region of the slat merge in interlocking manner, and wherein the transition between front region and back region of the slat is without contouring and that the slat has a flat, wavy and/or polygonal cross-sectional structure.

15. The slat according to claim 13, wherein the front region and the back region of the slat are formed of thermoplastic plastics material, the front region having a modulus of elasticity of at least 12,000 MPa and the back region a modulus of elasticity of at most 5,000 MPa, and wherein the slat is produced in a two-component injection-moulding process and that fibres of carbon, metal, glassfibres or plastic with a roughened surface or metal thread sections are added to the thermoplastic plastics material of the front region.

16. The slat according to claim 13, wherein due to the lower bending stiffness the back region of the slat is bendable in the transverse direction (y) without fracture of the slat, and nestles against adjoining contact surfaces and produces sealing with contact surfaces.

17. An air vent comprising at least one slat having the features of claim 13, wherein the air vent comprises a housing having a front air outlet opening and a rear connection to an air feed shaft for the supply of an air flow, wherein the at least one slat is so arranged in the front region of the housing at a support unit that the air flow is deflectable by the at least one slat, wherein the position of the at least one slat in the housing is variable in a horizontal direction by the support unit and/or the slat is mounted at the support unit to be rotatable about a horizontally extending axis or the at least one slat is arranged in a stationary position in the housing at the support unit.

18. The air vent according to claim 17, wherein the support unit is a strut or a roller arranged to be rotatably mounted in a region of the air outlet opening of the housing.

19. The air vent according to claim 17, wherein the housing inner wall of the housing in a region of the air outlet opening forms a Cassinian curve in a shape of a lemniscate or an arc, the radius of which reduces in a direction of the air outlet opening and forms a constriction in a region of the contact surface between the back region of the at least one slat and the housing inner wall of the housing.

20. The air vent according to claim 17, wherein a grille is arranged in front of or in the air outlet opening to close this in interlocking manner.

21. The air vent according to claim 20, wherein the grille is formed by horizontally and vertically arranged webs and cut-outs formed between the webs, wherein the cut-outs are formed at different directional angles, wherein the directional angles of the cut-outs arranged in a horizontal central region in the air outlet opening extend perpendicularly to the webs and the directional angles of the cut-outs above the horizontal central region have an upwardly inclined angle and the cut-outs below this region a downwardly inclined angle, this angle preferably being between 30° and 45°.

22. The air vent according to claim 20, wherein the grille is in the form of a roller blind formed of flexible material is pushable in front of the air outlet opening or in the form of a visor is pivotable in front of the air outlet opening, the grille being pivotable or pushable into the housing.

23. The air vent according to claim 17, wherein disposed in the housing is an arrangement for guidance and/or deflection and/or suppressing the supplied air flow, which can be fed from an air feed shaft or from an air feed duct in heating, ventilating or air-conditioning installations, particularly for passenger compartments in motor vehicles, and that the housing is insertable into a wall passage or mountable behind such and that the arrangement is formed from at least two separate elements, which are offset relative to one another by an angle and/or arranged one behind the other, so that the supplied air flow in its flow direction can be set, deflected or almost completely suppressed, wherein the elements are at least one respective slat or at least one slat block, wherein a slat block comprises a plurality of intercoupled slats and wherein each one of the intercoupled slats of a slat block is so mounted in the slat block that the slats of a slat block are pivotable in common about an axis.

24. The air vent according to claim 17, wherein a constriction is formed in the housing, the construction being formed by a funnel.

25. The air vent according to claim 18, wherein the housing inner wall of the housing in a region of the air outlet opening forms a Cassinian curve in a shape of a lemniscate or an arc, the radius of which reduces in a direction of the air outlet opening and forms a constriction in a region of the contact surface between the back region of the at least one slat and the housing inner wall of the housing.

26. The air vent according to claim 21, wherein the grille is in the form of a roller blind formed of flexible material is pushable in front of the air outlet opening or in the form of a visor is pivotable in front of the air outlet opening, the grille being pivotable or pushable into the housing.

27. The air vent according to claim 18, wherein disposed in the housing is an arrangement for guidance and/or deflection and/or suppressing the supplied air flow, which can be fed from an air feed shaft or from an air feed duct in heating, ventilating or air-conditioning installations, particularly for passenger compartments in motor vehicles, and that the housing is insertable into a wall passage or mountable behind such and that the arrangement is formed from at least two separate elements, which are offset relative to one another by an angle and/or arranged one behind the other, so that the supplied air flow in its flow direction can be set, deflected or almost completely suppressed, wherein the elements are at least one respective slat or at least one slat block, wherein a slat block comprises a plurality of intercoupled slats and wherein each one of the intercoupled slats of a slat block is so mounted in the slat block that the slats of a slat block are pivotable in common about an axis.

28. The air vent according to claim 19, wherein disposed in the housing is an arrangement for guidance and/or deflection and/or suppressing the supplied air flow, which can be fed from an air feed shaft or from an air feed duct in heating, ventilating or air-conditioning installations, particularly for passenger compartments in motor vehicles, and that the housing is insertable into a wall passage or mountable behind such and that the arrangement is formed from at least two separate elements, which are offset relative to one another by an angle and/or arranged one behind the other, so that the supplied air flow in its flow direction can be set, deflected or almost completely suppressed, wherein the elements are at least one respective slat or at least one slat block, wherein a slat block comprises a plurality of intercoupled slats and wherein each one of the intercoupled slats of a slat block is so mounted in the slat block that the slats of a slat block are pivotable in common about an axis.

29. The air vent according to claim 20, wherein disposed in the housing is an arrangement for guidance and/or deflection and/or suppressing the supplied air flow, which can be fed from an air feed shaft or from an air feed duct in heating, ventilating or air-conditioning installations, particularly for passenger compartments in motor vehicles, and that the housing is insertable into a wall passage or mountable behind such and that the arrangement is formed from at least two separate elements, which are offset relative to one another by an angle and/or arranged one behind the other, so that the supplied air flow in its flow direction can be set, deflected or almost completely suppressed, wherein the elements are at least one respective slat or at least one slat block, wherein a slat block comprises a plurality of intercoupled slats and wherein each one of the intercoupled slats of a slat block is so mounted in the slat block that the slats of a slat block are pivotable in common about an axis.

30. The air vent according to claim 21, wherein disposed in the housing is an arrangement for guidance and/or deflection and/or suppressing the supplied air flow, which can be fed from an air feed shaft or from an air feed duct in heating, ventilating or air-conditioning installations, particularly for passenger compartments in motor vehicles, and that the housing is insertable into a wall passage or mountable behind such and that the arrangement is formed from at least two separate elements, which are offset relative to one another by an angle and/or arranged one behind the other, so that the supplied air flow in its flow direction can be set, deflected or almost completely suppressed, wherein the elements are at least one respective slat or at least one slat block, wherein a slat block comprises a plurality of intercoupled slats and wherein each one of the intercoupled slats of a slat block is so mounted in the slat block that the slats of a slat block are pivotable in common about an axis.

31. The air vent according to claim 22, wherein disposed in the housing is an arrangement for guidance and/or deflection and/or suppressing the supplied air flow, which can be fed from an air feed shaft or from an air feed duct in heating, ventilating or air-conditioning installations, particularly for passenger compartments in motor vehicles, and that the housing is insertable into a wall passage or mountable behind such and that the arrangement is formed from at least two separate elements, which are offset relative to one another by an angle and/or arranged one behind the other, so that the supplied air flow in its flow direction can be set, deflected or almost completely suppressed, wherein the elements are at least one respective slat or at least one slat block, wherein a slat block comprises a plurality of intercoupled slats and wherein each one of the intercoupled slats of a slat block is so mounted in the slat block that the slats of a slat block are pivotable in common about an axis.
